(19) United States
(12) Patent Application Publication
(10) Pub. No.: US 2014/0077007 A1
(43) Pub. Date: Mar. 20, 2014

(54) Methods of Processing Waste Material to Render a Compostable Product

(71) Applicant: NATIONAL RECOVERY TECHNOLOGIES, LLC, Nashville, TN (US)

(72) Inventors: Edward J. Sommer, JR., Nashville, TN (US); Dane H. Campbell, Albany, OR (US); Robert H. Parrish, Nashville, TN (US)

(73) Assignee: NATIONAL RECOVERY TECHNOLOGIES, LLC, Nashville, TN (US)

(21) Appl. No.: 13/786,923

(22) Filed: Mar. 6, 2013

Related U.S. Application Data
(60) Provisional application No. 61/703,355, filed on Sep. 20, 2012.

(51) Int. Cl. B07B 9/00; B02C 23/08

(52) U.S. Cl. CPC B07B 9/00; B02C 23/08
USPC 241/24.12; 209/12.1; 209/44.1; 241/68

(57) ABSTRACT

Disclosed herein are methods of processing municipal solid waste in order to isolate a compostable product. The methods and system disclosed allow for municipal solid waste to be separated into an organic fraction and an inorganic fraction. The purity of the organic fraction may be enhanced in certain methods. The overall yield of organic material may be increased by subjecting inorganic material to further separation steps.

This application claims benefit of U.S. Provisional Patent Application Ser. No. 61/703,355, filed Sep. 20, 2012, entitled “Methods of Processing Waste Material to Render a Compostable Product” which is hereby incorporated by reference in its entirety.

### STATEMENT REGARDING FEDERALLY SPONSORED RESEARCH OR DEVELOPMENT

Not applicable.

### BACKGROUND OF THE INVENTION

Municipal solid waste (“MSW”) contains that which its name implies, solid waste from a municipality. MSW may include, for example, glass, plastic, rubber, PVC, rock, ceramic material, cardboard, paper waste, food waste, fabric waste, and the like. Often it is wet as it is exposed to environmental conditions, such as rain, as well as moisture from organic products within it and half finished water bottles and the like. However, part of it may be dry. It contains many different materials.

Processing MSW presents challenges. The general condition of the waste offers unique problems that need to be solved. Depending on exposure to physical elements, such as rain or the drying effects of the sun, in addition to the wide variety of storage conditions for MSW, processing it in order to isolate certain materials is challenging. Processing MSW requires a procedure which overcomes these physical characteristics in order to allow for the separation and isolation which is desired. The need is great for enhancing existing processing methods.

### SUMMARY OF THE INVENTION

The present invention provides a method of sorting waste material to separate compostable material. The method includes the steps of sizing a waste material to be a first size waste material; delivering the first size waste material to a sizing screen; separating out a second size waste material from the first size waste material by use of a sizing screen, wherein the second size waste material is removed and the remaining first size waste material is referred to as suitable size waste material; delivering to a first vibrating feeder the suitable size waste material; vibrating the suitable size waste material; sorting the suitable size waste material in a first sorter in order to separate the suitable size waste material into a first organic fraction and a first inorganic fraction; vibrating the first organic fraction in a second vibrating feeder; sorting the first organic fraction in a second sorter into a second organic fraction and a second inorganic fraction so that the second organic fraction contains less inorganic material than the first organic fraction; and collecting the second organic fraction. In certain embodiments, the method further includes vibrating the first inorganic fraction in a third vibrating feeder; sorting the first inorganic fraction in a third sorter into a third organic fraction and a third inorganic fraction in order to increase the yield of organic material available for collection; and collecting the third organic fraction. In other embodiments, the method further includes adding the third organic fraction to the second organic fraction. In still other embodiments of the method, sorting the first inorganic fraction in the third sorter further includes sorting the first inorganic fraction in an x-ray sorter. In other embodiments, sorting the first inorganic fraction in the third sorter further includes sorting the first inorganic fraction in an air aspiration type sorter. In yet other embodiments, sorting the first inorganic fraction in the third sorter further includes sorting the first inorganic fraction in a density type sorter. In certain embodiments, sizing the waste material to be the first size further includes sizing the waste material to be two inch minus waste material. In yet other embodiments, separating out the second size waste material further includes separating out waste material being 0.5 inch minus waste material.

In alternate embodiments, the invention is a method of sorting waste material to separate compostable material, including sizing a waste material to be a first size waste material; delivering the first size waste material to a sizing screen; separating out a second size waste material from the first size waste material by use of a sizing screen, wherein the second size waste material is removed and the remaining first size waste material is referred to as suitable size waste material; delivering to a first vibrating feeder the suitable size waste material; vibrating the suitable size waste material; sorting the suitable size waste material in a first sorter in order to separate the suitable size waste material into a first organic fraction and a first inorganic fraction; vibrating the first inorganic fraction in a second vibrating feeder; sorting the first inorganic fraction in a second sorter into a second organic fraction and a second inorganic fraction so that the second inorganic fraction contains less organic material than the first inorganic fraction; and collecting the second organic fraction. In certain embodiments, the method further includes adding the second organic fraction to the first organic fraction. In yet other embodiments, sorting the suitable size waste material in the first sorter further includes sorting the suitable size waste material in an x-ray sorter. In yet other embodiments, sorting the first organic fraction in the second sorter further includes sorting the first organic fraction in an x-ray sorter. In alternate embodiments, the method is performed generally in line so that the suitable size waste material being sorted does not encounter any sharp side to side changes in its path.

Other embodiments of the invention disclose a sorting system, including a sizing screen, wherein the sizing screen defines a plurality of interfacial openings of a second size so that second size or smaller waste material is filtered out from a waste material being sorted by the sizing screen; a first vibrating feeder positioned to receive the waste material from the sizing screen so that the waste material being sorted is received and vibrated; an accelerated conveyor positioned to receive the waste material from the first vibrating feeder; a first sorting device positioned to receive the waste material from the accelerated conveyor, wherein the first sorting device is calibrated to sort the waste material into a first organic fraction and a first inorganic fraction; a second vibrating feeder positioned to receive the first organic fraction from the first sorting device; and a second sorting device positioned to receive the first organic fraction from the second vibrating feeder, wherein the second sorting device is calibrated to sort the first organic fraction into a second organic fraction and a second inorganic fraction. In certain embodiments, the sorting system further includes a third vibrating feeder positioned to receive the first inorganic fraction from the first sorting device; and a third sorting device positioned to receive the first inorganic fraction form the third vibrating feeder, wherein the third sorting device is calibrated to sort the first inorganic fraction into a third organic fraction and a third inorganic fraction so that the yield of organic material increases. In yet other embodiments, each of the sizing screen, the first vibrating feeder, the accelerated conveyor, the first sorting device, the second vibrating feeder, the second sorting device, the third vibrating feeder, and the third sorting device are positioned generally in line so that the waste material being sorted does not travel on a sharply angled horizontal path. In alternate embodiments, the sorting system further includes a material sizing device positioned to deliver the waste material to be sorted to the sizing screen, wherein the sizing device sizes waste material to a first size. In certain embodiments, the first size is two inch minus. In other embodiments, each of the sizing screen, first vibrating feeder, accelerated conveyor, first sorting device, second vibrating feeder, and second sorting device are positioned generally in line so that the waste material being sorted does not travel on a sharply angled horizontal path. In still other embodiments, the plurality of interfacial openings are sized so that 0.5 inch minus waste material is filtered out from the waste material being sorted by the sizing screen. In other embodiments, the third sorting device is an x-ray sorter. In alternate embodiments, the third sorting device is an aspiration type sorter. In still other embodiments, the third sorting device is a vibratory destoner sorter. In certain embodiments, the sorting system further includes a collection container positioned to receive the second organic fraction from the second sorting device. In still other embodiments, the sorting system further includes a collection container positioned to receive the third organic fraction from the third sorting device. In yet other embodiments, the sizing screen is a debris roll screen.

### BRIEF DESCRIPTION OF THE DRAWINGS

FIG. 1 depicts a schematic diagram showing the mechanical arrangement of portions of an embodiment of the present invention in which a single sorting device is used in combination with a debris roll screen and a vibrating feeder.

FIG. 2 depicts a schematic drawing of the mechanical arrangement of portions of an embodiment of the invention in which two sorting devices are used in combination with vibrating feeders and accelerated conveyors.

FIG. 3 depicts an illustration of a schematic drawing showing the arrangement of portions of an embodiment of the invention in which three sorting devices are used to separate compostable material, in greater purity and with greater yield.

FIG. 4 depicts a perspective view of an embodiment of the present invention showing the additional support structures needed to such an embodiment.

FIG. 5 is a perspective view of a schematic drawing of a debris roll screen. Shown therein are the disks and the interfacial openings which are used for material separation.

FIG. 6 depicts a side view illustration of a schematic showing mechanical arrangement of portions of an embodiment of a materials sorting system.

FIG. 7 depicts a top view illustration of the schematic of FIG. 6 showing mechanical arrangement of portions of an embodiment of a materials sorting system.

FIG. 8 shows a block diagram for an embodiment of a materials sorting system illustrating relationships between various portions of the electrical/computer hardware for acquiring and processing x-ray detector signals and for activating selected air valves within an air ejector array responsive to the results of the processing.

FIG. 9 shows an example graph of processed x-ray transmission data measured at two different x-ray energy levels for various nonferrous metals derived from an automobile shredder.

FIG. 10 shows a logic flow diagram representative of a materials identification and sorting algorithm.

### DETAILED DESCRIPTION OF THE INVENTION

The present invention disclosed herein is a method of processing waste material to render a compostable product. Municipal solid waste (“MSW”) is a material that is difficult to process due to the wide spectrum of physical conditions that make up its content. MSW contains that which its name implies, solid waste from a municipality. MSW may include, for example, glass, plastic, rubber, PVC, rock, ceramic material, cardboard, paper waste, food waste, fabric waste, and the like. Often it is wet as it is exposed to environmental conditions, such as rain, as well as moisture from organic products within it and half finished water bottles and the like. However, part of it may be dry. It contains many different materials. Depending on exposure to physical elements, such as rain or the drying effects of the sun, in addition to the wide variety of storage conditions for MSW, processing it in order to isolate materials which may be used for compost is challenging. There is a real propensity for MSW to clump and aggregate due to it final content and storage conditions. Accordingly, processing MSW requires a procedure which overcomes these physical characteristics in order to allow for the separation and isolation of organic material which may be used as a compost material in a residential setting, an alternate daily cover in an industrial setting, or for anaerobic digestion processes The need is great for such a compost material in the residential and agricultural arenas.

Multiple methods for processing MSW for the isolation of compostable material are disclosed herein. Each method allows for the isolation of compostable material having varying levels of purity and varying levels of yield. By way of example, isolation of compostable for use as an alternative daily cover will differ from the method of isolating a residential grade compostable material.

Isolation of a material that will be a preferred material for composting requires the ability to break apart, or fragment, aggregated clumps of MSW. The method then requires the ability to identify and separate organic material from inorganic material. Organic material is the compostable material. The non-compostable material is the inorganic material, such as glass, rock, metals, and other materials containing significant amounts of high Z (i.e. high atomic number) elements. Inorganic materials do not decompose or break down and actually continue to exist for many, many years. Accordingly, removal of inorganic material from a compostable material is important. For example if small pieces of broken glass (inorganic material) are included in compost material for agricultural fields, at a point in the future after the organic material has decomposed, the small pieces of glass will remain in soil which, clearly, is not desirable in an agricultural field.

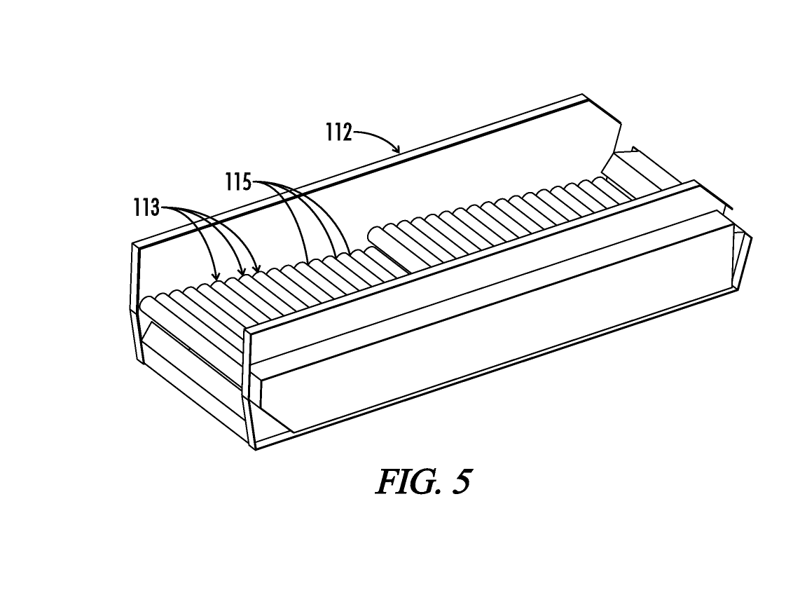

The first part of the method of processing MSW is to properly size the solid waste 126 which will be sorted. Material sizing devices 142 are known in the industry and are readily commercially available. An example of such a material sizing device 142 is a trommel screen. By the way of example, the trommel screen is commercially available from Central Manufacturing in Groveland, Ill. Another example is a debris roll screen 112 which relies on shafts with sizing discs, that is commercially available from Bulk Handling Systems of Eugene, Oreg. In still other embodiments of the invention, a sizing screen device that utilizes vibration to agitate material over a sizing surface may be used. By way of example, the vibratory screen is commercially available from Ball Engineering in Huntington Beach, Calif. In the preferred methods disclosed herein the solid waste 126 is sized by a material sizing device 142 to be two inches or less in size. In certain embodiments, the material sizing device 142 may be a debris roll screen 112 which sizes the solid waste 126 to be two inches or less in size. For the avoidance of doubt, sizing screens 111 include trommel screens, debris roll screens, vibratory screens and the like, as is known to those of ordinary skill in the art. Other sizes of materials could be used. In alternate embodiments, the solid waste 126 is sized to be three inches or less in size. Properly sized solid waste 126 is then delivered to a conveyor system 150 to next be subjected to a fines screen. A fines screen is also called a sizing screen 111 within this application. Sizing screens 111 are well known in the industry and are readily commercially available. For the avoidance of doubt, sizing screens 111 include trommel screens, debris roll screens, vibratory screens and the like, as is known to those of ordinary skill in the art. In certain embodiments of the present invention, within the methods described herein, the sizing screen 111 is a debris roll screen 112. A suitable debris roll screen 112 is commercially available from Bulk Handling Systems of Eugene, Oreg. The debris roll screen 112 of the current method has a plurality of interfacial openings 115 so that smaller sized material is separated out, as best seen in FIG. 5. As further described in the paragraphs below, the specific size of the interfacial openings 115 may vary. By way of example, the openings may have a size of one-half inch so that materials one-half inch in size or smaller are separated out into a residue collection conveyor, or the like. The combination of the material sizing device 142 and the debris roll screen 112 allows for solid waste 126 being sized, in certain embodiments, from two inches to 0.5 inch for separation activities in order to isolate organic material.

Clearly, an important aspect of the system and method disclosed herein is the proper sizing of waste material before starting the sorting process. Specifically, with regard to isolating compostable material, action is needed to identify an upper size limit as well as a lower size limit for the solid waste material 126 which is the subject of sorting. In certain embodiments of the invention, the upper size limit of the waste material 126 is a first size waste material 156, which is a size to be identified one of ordinary skill in the art with regard to specific details relevant to the sorting activity being performed. In alternate embodiments of the present invention, the first size waste material 156, or upper limit, may be about two inches, so that material having a size of two inches or less is the subject of sorting. In yet another embodiment of the present invention, the first size waste material 156, or upper limit, may be about three inches, so that material having a size of three inches or less is the subject of sorting. Equally important is the establishment of a lower size limit so that the machinery and methodology perform at an optimal level. In certain embodiments of the present invention, after first being sized to a first size waste material 156, the waste material 126 is then placed on a sizing screen 111 such as a debris roll screen 112 in order to separate out waste material of a second size 158, that is, if waste material is a second size or smaller, it is removed so that such small waste material is not subject to further sorting. In alternate embodiments of the present invention, the second size waste material 158, or lower size limit, may be 0.5 inches. Accordingly, waste material having a size of 0.5 inches or less is removed from the sorting process. In alternate and still other embodiments, the lower size limit may be 0.38 inch. In yet other embodiments, the lower size limit may be 0.375 inch, which is ⅜ inch. MSW which is properly sized does not contain significant amounts of material larger than the first size 156, or upper limit, and does not contain significant amounts of material smaller in size than the second size 158, or lower size limit. Such properly sized MSW is referred to herein as suitable size waster material 160. Suitable size waste material 160 is the subject of sorting by use of the invention disclosed herein.

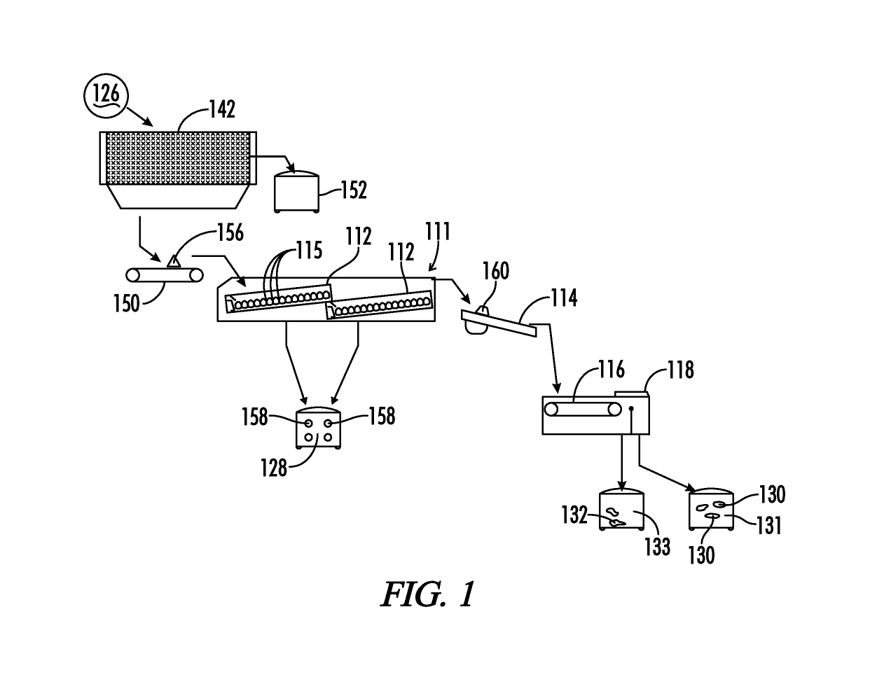

Referring now to FIG. 1, there is shown a schematic diagram of an embodiment of the system used to accomplish the methods disclosed herein. The use of the material sizing device 142, conveyor system 150, and debris roll screen 112 have been described above. Properly sized solid waste, referred to as suitable size waste material 160, is delivered to a first vibrating feeder 114. That is, the vibrating feeder 114 is positioned to receive the suitable size waste 160. As used herein, the language “positioned to receive” means that the material being sorted is received by the device, such as directly receiving, or receiving after the material is transported via conveyor, or the like. Vibrating feeders are well known in the industry and widely commercially available. An example of a suitable vibrating feeder is the Electromechanical Feeder, Brute force, dual drive feeder, made by Eriez of Erie, Pa. The vibrating feeder vibrates, fragments, and otherwise breaks apart the suitable size waste material 160 in order to enhance the subsequent separating step. Another function of the vibrating feeder is to evenly distribute the suitable size waste material 160 as it enters a sorting device for better sorting results. The suitable size waste material 160 then travels to a first accelerated conveyor 116. The first accelerated conveyer 116 feeds the waste material 160 into the first sorting device 118. An example of a suitable accelerated conveyor is 40 inches wide, 10 feet in length, operable at speeds up to 10 ft/sec, which is commercially available from National Recovery Technologies LLC, of Nashville, Tenn.

The first sorting device 118 is a sorting device capable of distinguishing organic material from inorganic material. In certain embodiments of the present invention, the sorting device technology will be measuring and detecting the Z value of the waste material 160 passing through the device and identifying its compounded atomic number. An example of a suitable first sorting device 118 is the model DXRT sorter, which is commercially available from National Recovery Technologies, LLC of Nashville, Tenn. In certain embodiments of the invention, the sorting devices 118, 124, and 148 may have a 40 inch wide sorting area. Further details of this specific sorting device are disclosed below. In alternate embodiments of the present invention, an alternate sorting device may be used as long as it is capable of identifying and separating organic material from inorganic material.

Still referring to FIG. 1, there is shown an embodiment of the present system in which a single sorting device is used to sort MSW into a first organic fraction 130 and a first inorganic fraction 132. Solid waste 126 is sized so that overly large materials are not included. The resulting waste is called first size waste material 156 and flows to the conveyor 150. In certain embodiments, such first size waste material 156 is two inch minus material. Material larger than two inch minus size can be collected in a collection bin 152. The conveyor 150 feeds the first size waste material 156 to the debris roll screen 112. The debris roll screen 112 separates out smaller sized material, which is called second size waste material 158. In certain embodiments, second size waste material 158 is waste material that has a size of 0.5 inch or less. The waste material then having a size of less then two inches and more than 0.5 inch is referred to as suitable size waste material 160. Suitable size waste material 160 is fed onto the first vibrating feeder 114. Then, it goes to the first accelerated conveyor 116 and the first sorting device 118. The suitable size waste material 160 is then separated into a first organic fraction 130 and a first inorganic fraction 132. Collection bins can be used to capture the material. They are a first organic fraction collection bin 131 and a first inorganic fraction collection bin 133. All collection bins shown in the schematic figures are drawn as transparent just to show that the appropriate material is present in each of the collection bins.

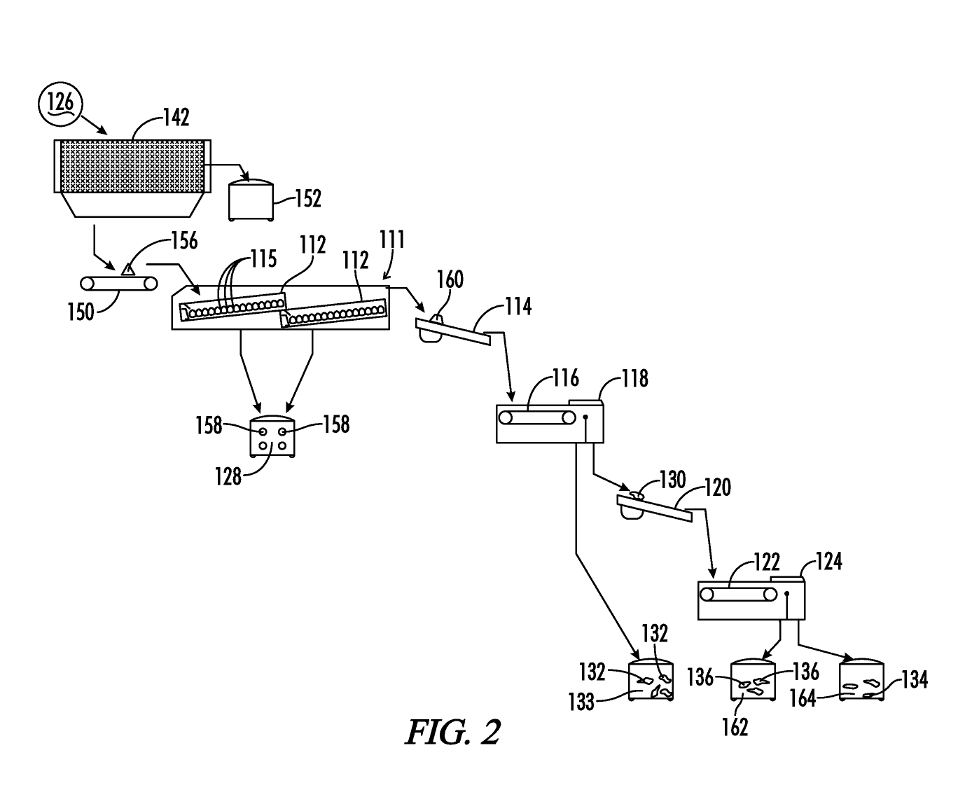

Referring now to FIG. 2, there is shown an alternate embodiment of the present system in which two sorting devices are used in order to obtain an organic material having a greater purity. The additional elements shown as compared to the previous figure are the flow of the first organic fraction 130. It is fed to a second vibrating feeder 120 which is then fed to the second accelerated conveyor 122 and the second sorting device 124. The second sorting device 124 separates the first organic fraction 130 into a second organic fraction 134, which can be collected in a collection bin 164, and a second inorganic fraction 136 which can be captured in collection bin 162. In certain embodiments of the present invention, the second sorting device 124 may be calibrated to perform a sorting function identical or similar to that performed by the first sorting device 118. Under such circumstance, the second separation by the second sorting device 124, of the first organic fraction 130 allows for other inorganic material, called the second inorganic fraction 136, to be removed from the second organic fraction 134, which is a more purified organic material having undergone a second separation. In certain embodiments of the present invention, the second inorganic fraction 136 is discarded. In alternate embodiments of the present invention, the second inorganic fraction 136 is kept for further processing.

The process of sorting MSW disclosed herein allows for a complete flexibility in the purification of organic material as well as other steps in order to increase the yield of organic material. In addition to further purifying the first organic fraction 130, as was described above, action may be taken to further separate the content of the first inorganic fraction 132. In certain embodiments of the present invention, rather than sorting the first organic fraction 130 in the second sorting device 124, it may be desirable to sort the first inorganic fraction 132 in the second sorting device 124. The action of the second sorting device 124 results in a second organic fraction 134 and a second inorganic fraction 136. It is noted that this separation step generates a second organic fraction 134 which was contained within the first inorganic fraction 132 and, but for the second separation, such additional organic material may have been discarded, or otherwise disposed of, as contents within the first inorganic fraction 132. Such an embodiment is described in detail in Example 2, below.

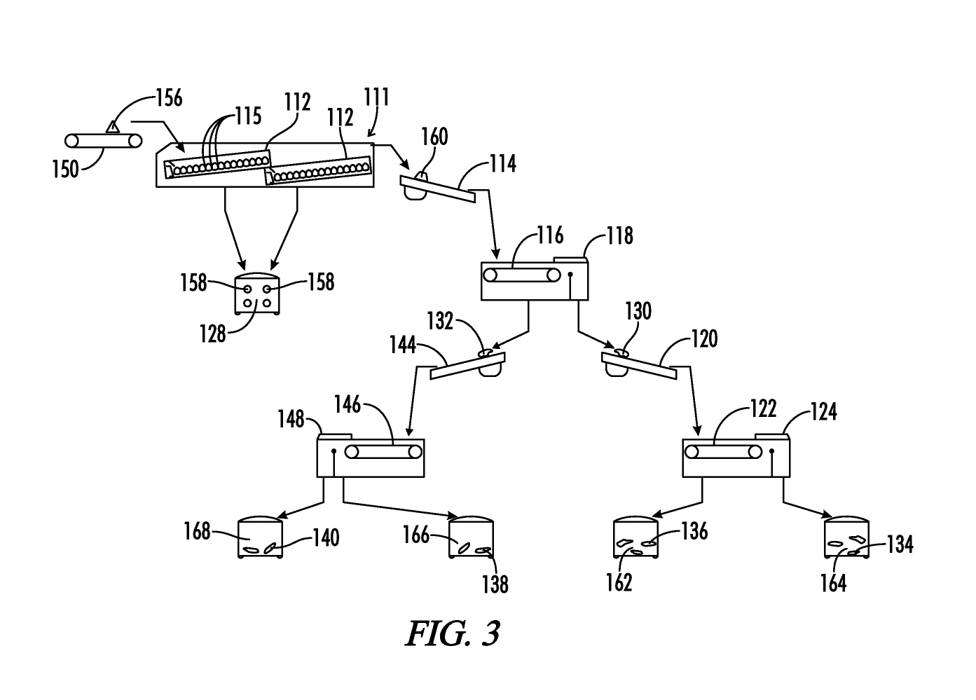

Referring now to FIG. 3, there is shown an embodiment of the present system in which three sorting devices are used in order to both enhance the purity of the organic material as well as increase the yield of organic material by further separating organic material from an inorganic fraction. As shown therein, after passing through the first sorting device 118, the first organic fraction 130 is fed to the second vibrating feeder 120 and then to the second accelerated conveyor 122, and then to the second sorting device 124. Separation by the second sorting device 124 results in a second organic fraction 134 and a second inorganic fraction 136, which can be collected in collection bins, 164 and 162, respectively. Alternatively the second inorganic fraction 136 can be combined with the first inorganic faction 132 from the first sorting device 118 and fed to a third vibrating feeder 144 and then to a third accelerated conveyer 146 and ultimately to the third sorting device 148. The result of the third sorting device 148 is a third organic fraction 138 and a third inorganic fraction 140, each which can be collected in collection bins, 166 and 168, respectively. Not shown on the Figure is the step of combining the second organic fraction 134 with the third organic fraction 138. However, such third organic fraction 138 may be added to the second organic fraction 134 in order to aggregate the organic material being collected herein.

One of ordinary skill in the art is familiar with the manner of positioning, arranging, and/or attaching the various elements of the system disclosed herein. One of ordinary skill in the art also is familiar with the power requirements of such elements of the system so that one of ordinary skill in the art may operate the systems which are disclosed herein.

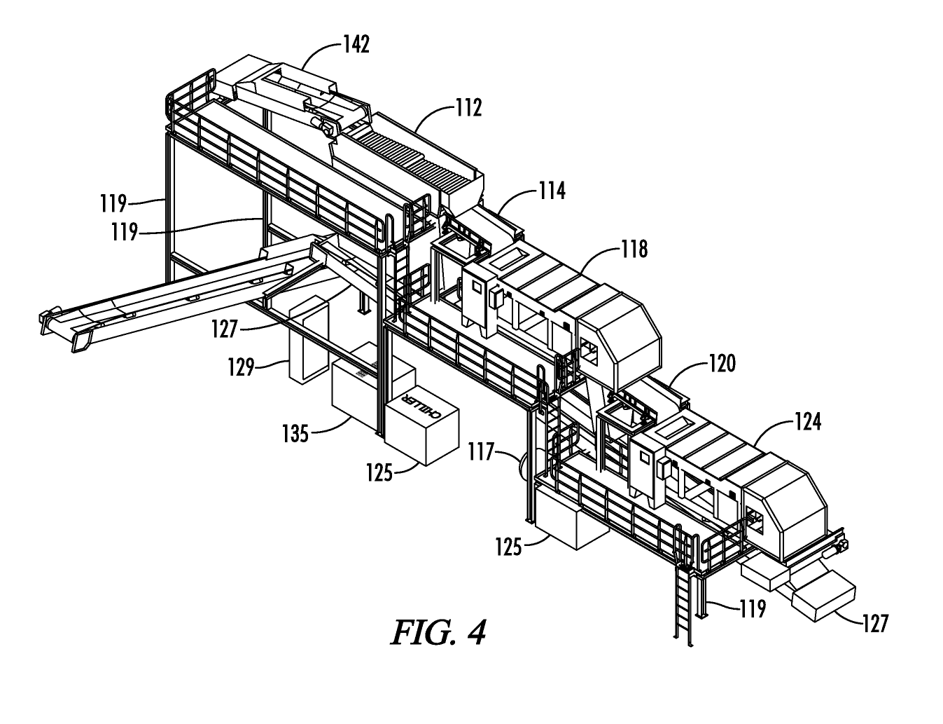

Referring now to FIG. 4, there is shown a perspective drawing of an embodiment of the present invention corresponding to that shown in FIG. 2. Shown therein is the attachment and proximity of the various elements of the system. The embodiment shown has a material sizing device 142, debris roll screen 112, first vibrating feeder 114, first sorting device 118, second vibrating feeder 120, second sorting device 124, a residue conveyor 127, support structures 119, a tank 117, optical machine chillers 125, compressor 135, and control cabinet 129. Compressor 135 is an air compressor that is required for the compressed air blasts that are used to eject organic contaminating material. The air compressor air outlet is connected to tank 117, which is an air reservoir tank. This tank 117 stores compressed air to reduce compressed air volume loss during material surge situations. It acts like a buffer. The tank 117 outlet is plumbed to the NRT DXRT air inlet manifold on which ejection valves are mounted. The NRT DXRT is a sorting device as described above. The chiller 125 provides a cooled fluid, such as water or a water/antifreeze mixture for cooling the x-ray system components in the detection system of the DXRT optical sorter. The residue conveyor 127 is used to collect and remove the ejected contaminants away from the desired material. Not shown are the respective accelerated conveyors which feed into the sorting devices, as those structures are not visible in the view which is shown. Also shown are support structures 119 which hold various elements of the system in their proper positions.

Referring now to FIG. 5, there is shown a perspective view of an embodiment of a debris roll screen 112. Shown therein are the disks 113 of the debris roll screen 112. The debris roll screen 112 defines a plurality of interfacial openings 115. Those interfacial openings 115 allow smaller size material to be separated from larger material. In certain embodiments of the present invention, each of the plurality of interfacial openings 115 result in the separation of 0.5 inch minus product. In alternate embodiments the present invention, each of the interfacial openings 115 is a size resulting in the separation of 0.38 inch minus product, or 0.25 inch minus product. Relating to use of the debris roll screen 112, as shown in other figures, the second size waste material 158 (the material being 0.5 inches or less) is received in a collection bin 128.

In certain embodiments of the present invention, the sorting steps may be performed at the rates as described in this paragraph. The material sizing device 142 produces roughly 17 tons per hour (tph) of two inch minus material. The debris roll screen 112 produces roughly 12 tph to about 13 tph of material over top of the screen to be fed to sorting system. The difference of roughly 3-6 tons is sub 0.5 inch minus material. The vibrating feeders and sorting devices 118, 124 and 148, when having a 40 inch wide conveyor, operate at a rate of 8-9 tph. The overall system can process up to 17 tph of MSW material.

Another aspect of the present invention is that the sorting method disclosed herein is to be performed generally in line so that the waste material being sorted does not encounter any sharp side-to-side changes in its path. Due to momentum of the MSW, and the rate at which the waste material being sorted moves through the system, any sharp or abrupt changes in direction complicate the sorting process. Vertical changes are tolerable. Accordingly, using gravity to drop MSW from a vibrating feeder onto a conveyor is acceptable. By way of a similar example, using gravity to transport an organic fraction from a sorting device into a collection bin is not problematic. However, abrupt horizontal changes in direction complicate sorting because of the lack of predicitabily of the position of each piece of waste in relation to the sorting process. By performing the method disclosed herein generally in line, abrupt side to side changes in the path of the waste material are avoided which enhances the results of the sorting activities. It is common for MSW to contain objects having circular or oval shapes which would be subject to rolling in response to an abrupt horizontal change of direction. As a further example, certain items in MSW may be wet or slippery such that those items when experiencing a sharp horizontal change of direction may slip or slide along its surface in response to physical forces. As disclosed herein, and shown in FIG. 4, it is preferable to avoid abrupt changes in horizontal direction.

### Sorting Devices

The method and system disclosed herein reference a number of sorting devices. For the avoidance of doubt, depending upon the embodiment of the method or system, the first sorting device 118, second sorting device 124, third sorting device 148, and any additional sorting devices, as needed, may be of the same type. In still other embodiments of the invention, each of the sorting devices may use a different sorting technology. For example, in a first embodiment, all sorting devices may be of an x-ray sorter type. In an alternate embodiment, the first sorting device 118 and second sorting device 124 may be of an x-ray sorter type, while the third sorting device 148 is an air aspiration type sorter, such as an air-knife. In still another embodiment, the third sorting device 148 may be a density type sorter, such as a vibratory destoner. With regard to the x-ray sorter type, disclosed below are details of an x-ray type sorter which is readily commercially available from National Recovery Technologies, LLC of Nashville, Tenn. Regarding the other types of sorter devices, note that air aspiration type sorters are well known in the industry and readily commercially available. For example, an air aspiration type sorter is commercially available from Air Assisted Aspirator from CSL, of Eugene, Oreg. The same is true of the density type sorters. Density type sorters are well know in the industry and readily commercially available from a source, for example, such as Destoner by Oliver of Rocky Form, Colo.

### An X-ray Sorting Device

The sorter described below uses analyses of x-ray absorptions in a material at differing energy levels in order to determine the relative atomic density (atomic number Z) of the material. The information below is from U.S. Pat. No. 7,564,943. Other U.S. patents related to that patent are U.S. Pat. Nos. 8,144,831; 7,848,484; and 7,099,433. All patents and references listed herein are hereby incorporated by reference herein, each in its entirety.

X-ray absorption in a material is a function of the atomic density of the material and also a function of the energy of the incident x-rays. A given piece of material will absorb x-rays to differing degrees depending upon the energy of the incident x-rays. Materials of differing atomic numbers will absorb x-rays differently. For instance copper (Z=29) will absorb x-rays much more readily than will aluminum (Z=13). Also the absorption profile of a given piece of copper over a range of x-ray energies will be different than the absorption profile of a given piece of aluminum over that same range of energies. X-ray transmission through a material is given by the equation

N₍ₜ₎=N₀e^{-ηρ}^{ₜ}

Where N₍ₜ₎ is the number of photons remaining from an initial N₀ photons after traveling through thickness t in a material of density ρ. The mass attenuation coefficient η is a property of the given material and has a dependence upon photon energy. The value ηρ is referred to as the mass absorption coefficient (μ) for a given material. Values of the coefficient μ have been established by researchers to high accuracy for most materials and these values are dependent upon the energy of incident x-ray photons. Values of μ/ρ(=η) for most materials can be found at the National Institute of Standards and Technology (NIST) internet website. The lists of values are extensive covering all stable elements for various values of photon energy (kev). The value of ρ for a given material is simply its density in gm/cm³ and can be found in many textbooks and also at the NIST website. The ratio N₍ₜ₎)/N₀ is the transmittance of photons through a thickness t of material and is often given as a percentage, ie. the percentage of photons transmitted through the material.

The following table, by way of example, gives values of the mass absorption coefficient μ for aluminum and copper over a range of incident x-ray photon energies and the percentage of photons remaining after passing through 0.2 cm of material (% transmission).

| | Incident Photon | Mass Absorption | |
|---|---|---|---|
| | Energy (kev) | Coefficient μ (cm⁻¹) | % Transmission |
| Aluminum | 100 | 0.46 | 91% |
| | 80 | 0.54 | 90% |
| | 60 | 0.75 | 86% |
| | 50 | 0.99 | 82% |
| | 40 | 1.53 | 74% |
| | 30 | 3.04 | 54% |
| Copper | 100 | 4.11 | 44% |
| | 80 | 6.84 | 26% |
| | 60 | 14.27 | 5.8% |
| | 50 | 23.41 | 0.93% |
| | 40 | 40.95 | 0.03% |
| | 30 | 97.84 | <0.00% |

Using the information in the table above we can illustrate how aluminum in this case can be differentiated from copper by comparing ratios of % Transmission (T_{E}) at two different photon energy levels. For instance:

Ratios: T₁₀₀/T₅₀=1.11 for aluminum, T₁₀₀/T₅₀=47.3 for copper

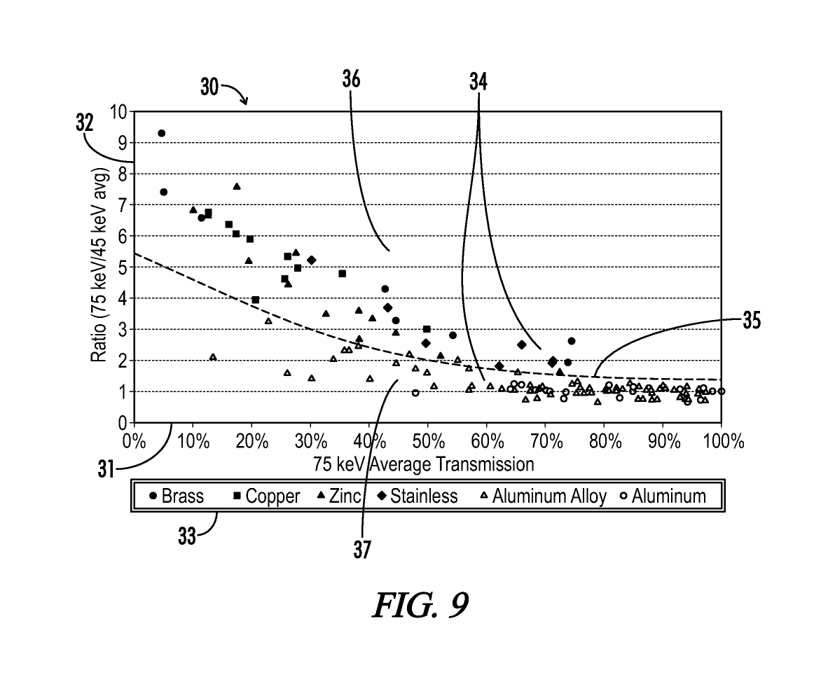

The ratio for copper is much higher than that for aluminum. Further, we find that for differing thicknesses of materials it is possible to distinguish between materials of differing Z value by comparing such ratios while correlating to levels of transmission of photon energy through the materials as is discussed in more detail later. This innovative analytical technique allows effectively differentiating between the materials independent of knowing or determining thickness of the materials as is further discussed in reference to FIG. 9.

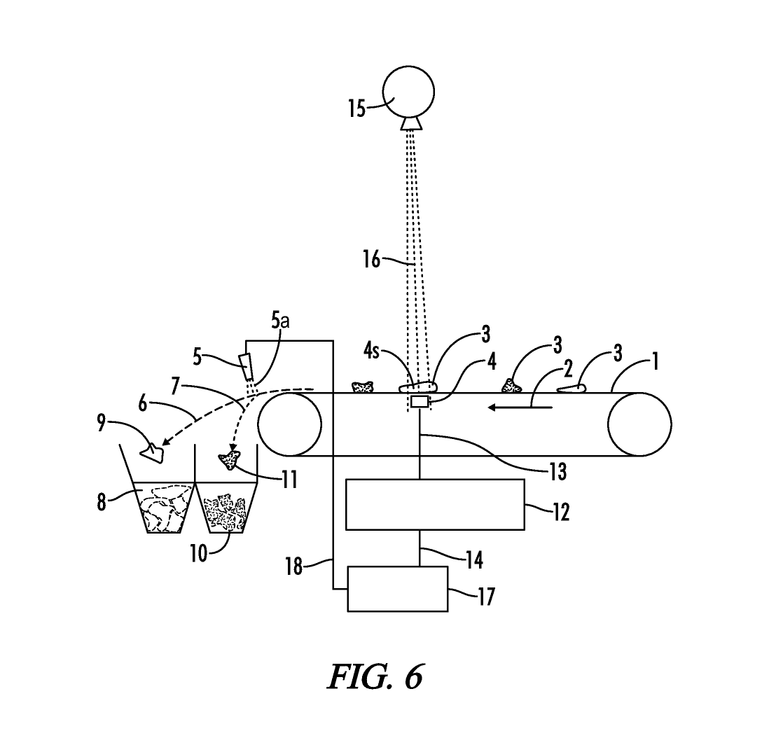

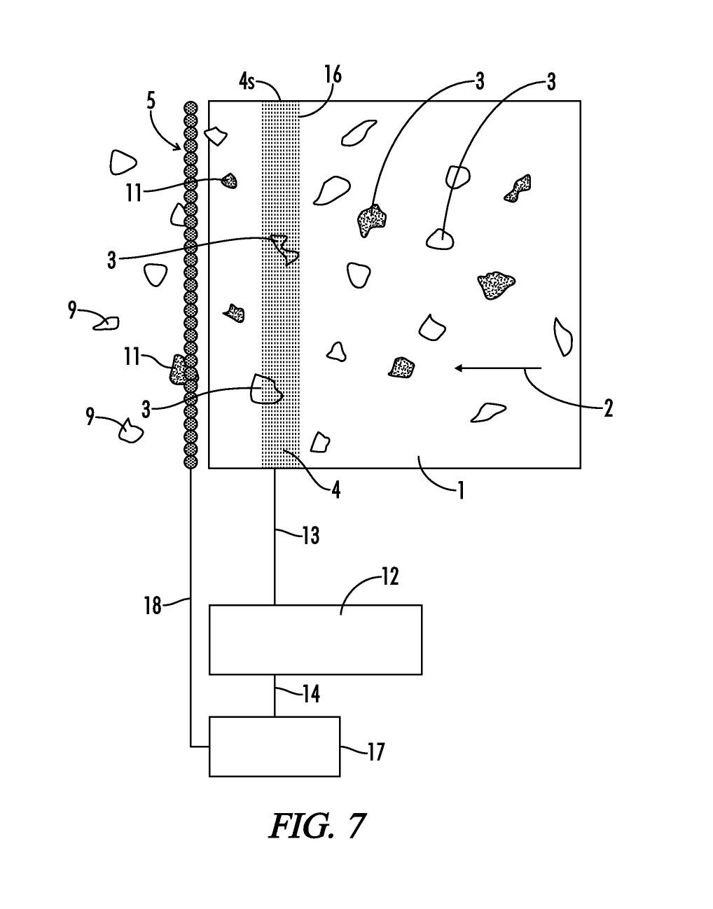

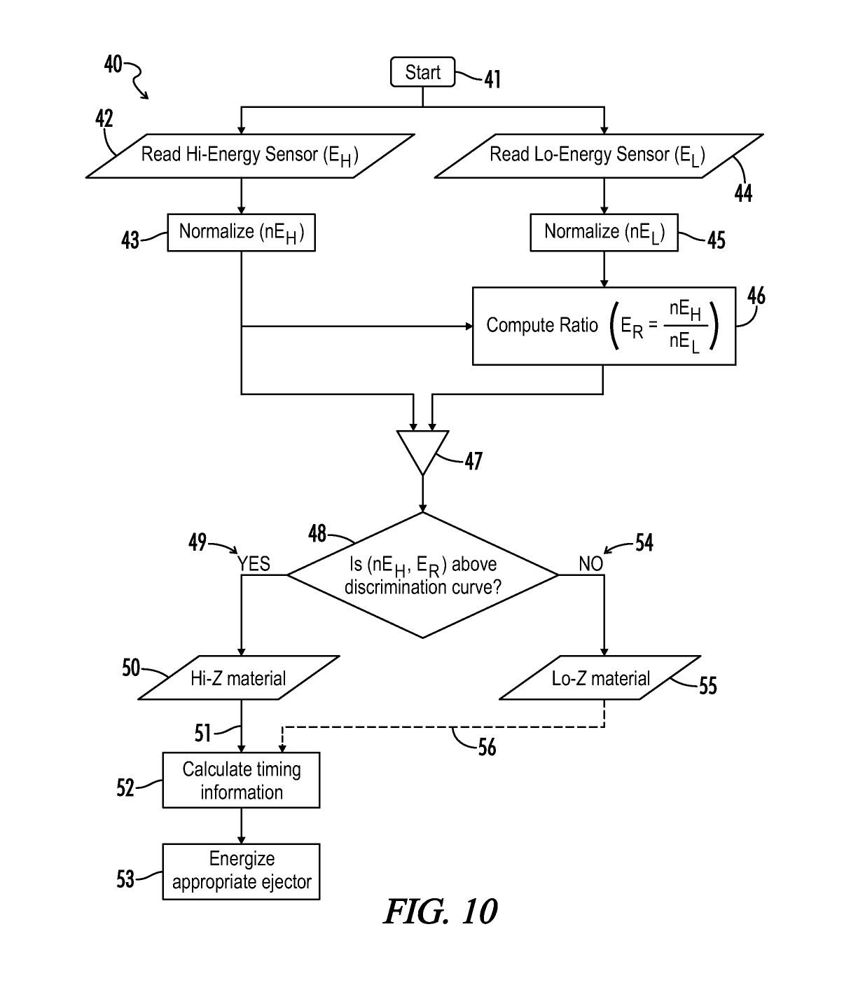

FIG. 6 shows a side view and FIG. 7 a top view of a schematic of mechanical arrangement of portions of a preferred embodiment of a materials sorting system that incorporates a dual energy x-ray detector array 4 positioned below the surface of a conveyor belt 1 used for transporting materials samples 3 into and through a sensing region 4s located on conveyor belt 1 between detector array 4 and x-ray tube 15. Belt 1 moves in a direction as shown by arrow 2 in FIG. 6 and FIG. 7. Detector arrays suitable for this use can be obtained from Elekon Industries, Torrance, Calif. X-ray tubes may be obtained from Lohmann X-ray, Leverkusan, Germany. Materials samples 3 may be a mixture of relatively high Z materials 11 (such as metals copper, iron, and zinc and their alloys—depicted by shaded samples) and relatively low Z materials 9 (such as metals magnesium and aluminum and their alloys—depicted by not shaded samples). The x-ray tube 15 is a broadband source that radiates a sheet of preferably collimated x-rays 16 across the width of conveyor belt 1 along the dual energy x-ray detector array 4 such that x-rays pass through sensing region 4s and conveyor belt 1 prior to striking detectors 4. Such a dual energy x-ray detector array 4 is well-known in the art, an example of which is described in detail in GE Medical Systems U.S. Pat. Nos. 6,266,390 and 6,519,315. As materials samples 3 pass through the sheet of x-rays in sensing region 4s x-rays transmitted through them are detected by the dual energy x-ray detector array 4 at two different energy levels. The detection signals are transmitted to computer system 12 over electrical connections 13 and the signals analyzed by a software algorithm 40 (FIG. 10) executing within computer system 12 to determine relative composition of samples 3 with respect to a preset relative composition level 35 (FIG. 9), as will be discussed in more detail later. In the example shown computerized algorithm 40 processes measurements of transmission levels of x-rays through materials at two energy levels using data from detector array 4 and makes a classification of each material sample 3 as being a relatively low Z material 9 or as being a relatively high Z material 11 with respect to preset relative composition level 35 and selects either low Z materials 9 or high Z materials 11 for ejection from the stream. Downstream from the sensing region 4s, located just off the discharge end of the conveyor belt 1 and positioned across the width of the trajectory paths 6,7 of materials discharged off the end of conveyor belt 1, is an array of high speed air ejectors 5, such as the L2 series supplied by Numatics, Highland, Mich., which are controlled by computer system 12, responsive to the algorithm 40 computations, by signaling air ejectors controller 17 through connections 14 to selectively energize through connections 18 appropriate air ejectors within air ejectors array 5 to deflect by short air blasts 5a selected materials from the flow. In the example shown relatively high Z metals 11 are selected for ejection along trajectories 7 into the metal group1 bin 10 and relatively low Z metals 9 pass unejected along trajectories 6 into metal group2 bin 8. It is noted that the system can just as easily be configured by the user through a standard control interface (not shown) to eject low Z materials into group1 bin 10 and let high Z materials pass unejected into group2 bin 8. It will be apparent to those skilled in the art that three or more bins could be utilized using multi-directional air ejectors or other sorting means. The sequence of sensing, selection, and ejection can happen simultaneously in multiple paths along the width of the conveyor belt 1 so that multiple metal samples 3 can be analyzed and sorted coincidentally as indicated in FIG. 7.

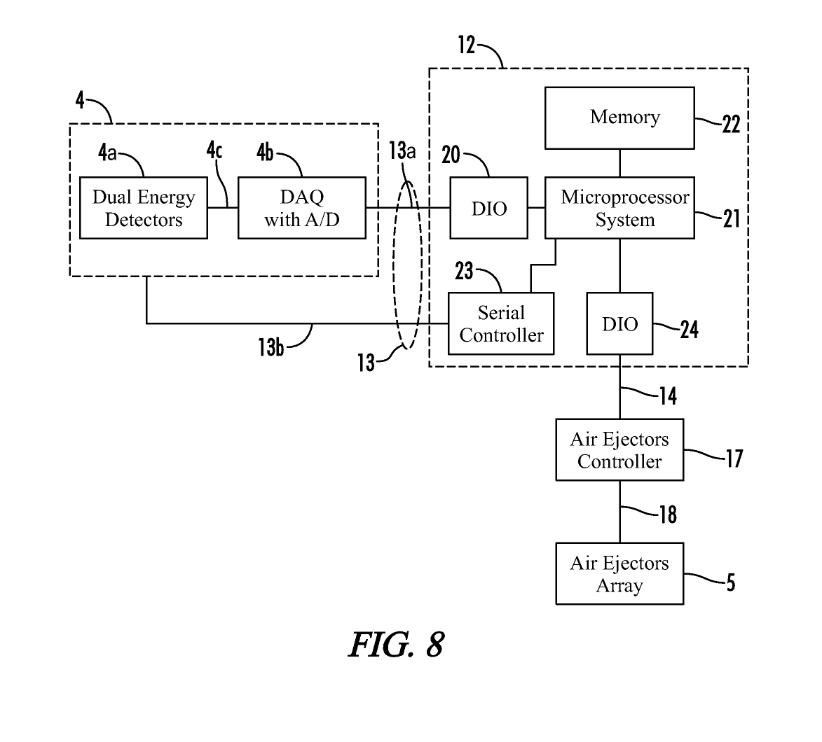

FIG. 8 shows a block diagram for an embodiment illustrating relationships between various portions of the electrical/computer system for acquiring and processing x-ray detector signals and for activating selected air valves within air ejector array 5 responsive to the results of the processing. The dual energy detector array 4 in this embodiment includes within its circuitry the dual energy x-ray detectors 4a and a data acquisition system (DAQ) with analog to digital (A/D) circuitry 4b for acquiring analog signals from the detectors over connections 4c and converting these signals to digital signals. The digital signals are transmitted over connections 13a, which are part of the electrical connections 13 between computer system 12 and dual energy array 4, to digital input/output (DIO) module 20. For this data transfer the input function of module 20 is utilized. Internal to computer system 12 DIO module 20 passes the digital data to microprocessor system 21. Microprocessor system 21 may be a single microprocessor or a system of multiple microprocessors linked together to share computational tasks to enable high speed data processing as is the case for this preferred embodiment. A suitable multiple microprocessor system is the Barcelona-HS available from Spectrum Signal Processing, Burnaby, Canada. Microprocessor 21 provides control signals to dual energy array 4 through serial controller 23 over electrical connection 13b. Materials classification and sorting algorithm 40 (FIG. 10), which is discussed in more detail later, executes within microprocessor system 21 processing digital data received from dual energy array 4 and utilizes computer memory 22 for storing data and accessing data during execution. According to results derived through executing of algorithm 40 microprocessor system 21 signals air ejectors controller 17, for example a bank of solid state relays such as those supplied by Opto22, Temecula, Calif., through DIO module 24 to energize selected air ejectors within air ejector array 5 over connections 18 so to eject from the flow of materials 3 selected materials 11 according to computed relative composition as the materials are discharged off the discharge end of conveyor 1. The user of the sorting system may chose through a standard control interface (not shown) for ejected materials 11 to be relatively high Z materials or relatively low Z materials, compared to preset relative composition level 35 (stored in memory 22) as determined by algorithm 40.

The x-ray technology measures changes in amount of x-ray transmission through an object as a function of energy. This technology can evaluate the entire object and looks through the entire object taking into consideration exterior and interior variations. The technology evaluates how the quantities of transmitted x-rays at various energy levels change as a function of the incident x-ray energy. One embodiment may be a multi-energy cadmium zinc telluride (CZT) pixel detection system arranged into a linear detector array of very small size is suitable to collect x-ray transmission information at each detector site and transmit it to an on-board computer system to collect data from multiple sensors simultaneously. Another embodiment may be an arrangement of multiple individual multi-energy detection systems such as those provided by Amptek, Bedford, Mass. Such systems could provide a greater number of energy bins. Multiple sub-systems could cover a wide conveyor belt. The data from the multi-detector array will provide multi-energy readings from each detector to provide an energy dispersive x-ray transmission profile of an object for assessing composition of a broad range of matter. Such a multi-energy CZT linear detector array having 32 CZT detectors at 0.5 mm pitch is available with supporting electronics from Nova R&D, Riverside, Calif. Each detector in the Nova R&D detection system can read and report x-ray transmission levels at up to five energy bands simultaneously at high rates of data acquisition and this capability is expected to expand to more energy bands as the technology is further developed. Further, the detectors have a spatial resolution of 0.02 inches per pixel in the array allowing detailed high resolution multi-energy profiling of x-ray transmission through an object under inspection. In effect one can build a high resolution multi-energy image of an object under inspection as the object is conveyed through the inspection region as well as simultaneously measuring the relative average atomic number of bits of matter within the image.

Such a system is functionally analogous to a line-scan camera commonly found in industrial inspection processes. Whereas a line-scan camera detects multiple “colors” within the visible spectrum, the system detects “colors” within the x-ray spectrum. Thus, the system may be characterized as a multi-spectral, x-ray camera providing a much richer data set than the dual energy techniques described in more detail herein. This multi-energy data set allows expanded imaging and material identification capabilities as described in general terms below.

While the new system provides data that can be represented by an x-ray image, an intelligent interpretation of that image is essential to identification and sortation of material. The presence of any atomic element is manifest by spectral peaks (from fluorescence) or discontinuities (from transmission) that result from electron-state transitions unique to that element. Since these peaks or edges occur in spectrally narrow regions (on the order of eV), detection of an element only requires monitoring a small portion of the spectrum. Unfortunately, the absorption edges of “interesting” elements span a wide energy range, from less than 1 keV to more than 80 keV. Additionally, material morphology and composition, processing rates and environment, and sensor response renders peak or edge detection as the exclusive method of sorting a wide variety of materials impractical. Peaks or edges may be used to discriminate among a subset of elements, but it is thought that interrogating a material's spectrum over a shorter energy range (shorter than 1 keV→80 keV) will divulge information sufficient for recycling purposes although a range double that (up to 160 keV) could be useful. In particular, applying derivatives, tangential intersections and spectral correlation to the absorption curve of a material could provide adequate discrimination among categories of recyclables.

When compared to the simple discriminators of difference or ratio, the proposed operations are, in general, more susceptible to noise within the response curve of a material. Thus, to generate meaningful descriptors, mitigating all forms of “noise” is advantageous. Since in one embodiment the system measures individual photons, the inherent noise from this method of detection is described by a Poisson distribution and can be reduced by collecting more photons. The nature of the CZT detectors in the Nova R&D linear array system limits the photon counting rate to approximately 50 million counts per second (MCount/Sec): the ensuing electrons further limit this rate to approximately 1 MCount/Sec. New systems under development could extend the counting rate by an order of magnitude (up to 500 MCount/sec). Since sufficiently “smooth” curves may require thousands of counts per acquisition, noise reduction through increased photon counts can result in decreased processing rates.

A material's absorption curve could prove sufficient for identification and sortation. However, certainty during the identification process may be augmented by fluorescence information. When x-rays pass through a material, some x-rays with energies greater than the electron excitation energy of constituent elements are absorbed and re-emitted as fluoresced photons. This process of absorption and re-emission is characterized in the transmission spectrum as an “absorption edge” and a “fluorescence peak,” where the peak is always near, but at a slightly lower energy than the edge. In a traditional absorption curve, the fluorescent peak is negligible. However, as a detector is gradually removed from the primary path of x-ray transmission, the signal contribution from primary x-rays are reduced and the contribution from secondary x-rays, such as fluorescence and scatter, are increased. Understandably, fluorescence is considered a “surface” phenomenon, but perhaps this information could enhance identification under certain conditions.

FIG. 9 shows an example graph 30 of processed x-ray transmission data measured for two different x-ray energy levels through various pieces of nonferrous metals derived from an automobile shredder. X-axis 31 of the graph represents normalized values of percentage transmission of x-rays (ie. transmittance values) through each metal piece as measured by the high energy detectors (item 43, FIG. 10) of array 4. Y-axis 32 of the graph represents values of the ratio (item 46, FIG. 10) of normalized values of percentage transmission of x-rays through each metal piece as measured by the high energy detectors of array 4 to the percentage transmission of x-rays through a material sample 3 as measured by the low energy detectors of array 4. In graph 30 data points 34 for the various metal samples are plotted according to their X-axis and Y-axis values. Legend 33 identifies each type data point as being for a brass, copper, zinc, stainless steel, aluminum alloy, or aluminum sample. Brass, copper, zinc, and stainless steel are considered to be relatively high Z metals and are represented by shaded data points in graph 30. Aluminum and aluminum alloys are considered to be relatively low Z metals and are represented by not shaded data points in graph 30. As can be seen in graph 30 data points for relatively high Z metals generally fall into a region 36 which resides above a region 37 into which fall data points for relatively low Z metals. A discriminator curve 35 has been drawn through the graph separating high Z region 36 from low Z region 37. This curve 35 in effect represents a preset relative composition level against which values (43,46) derived for a material sample can be compared to classify the sample as being either a relatively high Z material or as being a relatively low Z material. Other treatments of the x-ray transmission data can be utilized as well, for example locating paired logarithmic transmittance data points from the detectors in a two dimensional space with the logarithm of transmittance from the low energy detector being one axis of the space and the logarithm of transmittance from the high energy detector being the other axis. In this case a discriminator curve such as curve 35 may be found which will separate the two dimensional space into relatively high Z materials and relatively low Z materials independent of thickness of the materials. Those skilled in the art will recognize that there are numerous other methods of varying complexity for correlating data from the detectors so that regions of relative composition, such as high Z regions, low Z regions, and other Z regions can be reliably distinguished.

In an embodiment a classification and sorting algorithm 40, represented in FIG. 10, utilizes the above described type of data interpretation to classify samples as being composed of relatively high Z materials or relatively low Z materials and effects sorting of the samples accordingly. For this example a material sample 3 enters the sensing region 4s and the presence of the sample is detected by a drop in x-ray radiation received by the detectors beneath the sample at the detector array 4. This drop in radiation results in a drop in signal level from the detectors 4a. The measured drop in signal level is noted by microprocessor system 21 which is monitoring the signal levels and causes microprocessor system 21 to start 41 execution of identification and sorting algorithm 40. During execution of algorithm 40 the value E_{H} of a high energy sensor is read 42 and the value E_{L} of a corresponding low energy sensor is read 44. The values are normalized 43 and 45, for instance by subtracting out pre-measured detector noise and then scaling the readings to the detector readings when no materials are in region 4s over the detectors. These subtracting and scaling operations convert the sensor readings to transmittance values. Normalized value 43, (transmittance of the high energy region photons) is then divided by normalized value 45 (transmittance of low energy region photons) to compute a ratio E_{R} 46 of high energy transmittance to low energy transmittance. Ratio 46 is then correlated with normalized high energy transmittance 43 using a correlation function 47 which is electronically equivalent to plotting a data point (43,46) onto a graph such as that of FIG. 9. Step 48 in the algorithm then computes whether correlated data (43,46) electronically lies within a relatively high Z region 36 or a relatively low Z region 37. In the example shown, if the correlated data (43,46) electronically is in a high Z region 36 algorithm 40 returns YES determination 49 and the material is categorized as a high Z material 50. In the example shown the algorithm continues along path 51, calculates 52 position and timing information for arrival of sample 3 at the ejection array 5 needed to accurately energize downstream ejector mechanisms in array 5 and issues the necessary commands 53 at the right time to energize the appropriate ejectors to eject high Z material 50 from the flow 2 of materials 3. In this case materials determined to be low Z materials 55 by algorithm 40 returning a NO determination 54 will not be ejected by ejection array 5. Alternatively, the algorithm can be configured by the user through a standard user interface to the computer system 12 to not follow path 51 and to instead follow alternate path 56 so that materials that are determined to be low Z materials 55 are ejected by ejection array 5 and materials determined to be high Z materials 50 are not ejected by ejection array 5. Those skilled in the art will recognize that other similar algorithms can be applied according to the method selected for treatment of the detector data.

All references, publications, and patents disclosed herein are expressly incorporated by reference.

### EXAMPLES

### Example 1

In a first embodiment of the process disclosed herein, the solid waste 126 being sorted is placed in a material sizing device 142 so that waste 126 having a size of two inches or less is then delivered to a conveyor 150 for delivery to a debris roll screen 112. The debris roll screen 112 separates out any material having a size of a one half inch or less. Such one half inch or less material is removed by placement on a residue collection conveyor. The suitable size waste material 160 having a size from about two inches to about a one half inch is delivered to a first vibrating feeder 114. The first vibrating feeder 114 helps breaks apart the waste 160 for more efficient separation. The first vibrating feeder 114 then delivers the waste 160 to a first accelerated conveyor 116 which feeds the waste 160 into the first sorting device 118 for sorting. The first sorting device 118 may be a device as described herein which is commercially available from National Recovery Technologies, LLC. As a result of the action of the first sorting device 118, the waste 160 is separated into a first organic fraction 130 and a first inorganic fraction 132. The first organic fraction 130 may be used as described elsewhere herein, such as for compost.

### Example 2

In certain embodiments of the process disclosed herein, further purification of the first organic fraction 130 is desirable. Further purification is accomplished by performing the following steps on the first organic fraction 130 from Example 1. The first organic fraction 130 is delivered to a second vibrating feeder 120 to allow fragmenting, or breaking apart of the material. The first organic fraction 130 is placed on a second accelerated conveyor 122 for delivery to a second sorting device 124. The result of the action of the second sorting device 124 is to separate the first organic fraction 130 into a second organic fraction 134 and a second inorganic fraction 136. The resulting second organic fraction 134 is a product that is available for use in composting or as otherwise described herein.

In still other embodiments of the process disclosed herein, further purification of the first inorganic fraction 132 may be desirable in order to increase the yield of organic matter available for use as a compost, or the like. In such an embodiment, further increase of yield is accomplished by performing the following steps on the first inorganic fraction 132 from Example 1. The first inorganic fraction 132 is delivered to a second vibrating feeder 120 to allow fragmenting, or breaking apart of the material. The first inorganic fraction 132 is placed on a second accelerated conveyor 122 for delivery to a second sorting device 124. The result of the action of the second sorting device 124 is to separate the first inorganic fraction 132 into a second organic fraction 134 and a second inorganic fraction 136. The resulting second organic fraction 134 is further product that is available for use in composting or as otherwise described herein.

### Example 3

In yet another embodiment of the present invention, the following steps result in the separation of the waste 126 into organic and inorganic fractions, with the additional separation of both of the organic and inorganic materials so that further organic material may be obtained from the inorganic material, in order to increase organic material yield. Also, the initial organic material is purified through the steps as disclosed in Example 2.

The first inorganic fraction 132 resulting from Example 1 goes through further separation. The first inorganic fraction 132 is subjected to fragmenting, or breaking apart, on a third vibrating feeder 134. The first inorganic fraction 132 is placed on a third accelerated conveyor 146 for delivery to a third sorting device 148 for sorting of it into a third organic fraction 138 and a third inorganic fraction 140. The third organic fraction 138 may be combined with the second organic fraction 134. The final organic composition is then put in use as described elsewhere in this application.

Thus, it is seen that the system and method of the present invention readily achieves the ends and advantages mentioned as well as those inherent therein. While certain preferred embodiments of the invention have been illustrated and described for purposes of the present disclosure, numerous changes in the arrangement and construction of parts may be made by those skilled in the art which changes are encompassed within the scope and spirit of the present invention as defined by the following claims.

What is claimed is:

1. A method of sorting waste material to separate compostable material, comprising:
sizing a waste material to be a first size waste material;
delivering the first size waste material to a sizing screen;
separating out a second size waste material from the first size waste material by use of a sizing screen, wherein the second size waste material is removed and the remaining first size waste material is referred to as suitable size waste material;
delivering to a first vibrating feeder the suitable size waste material;
vibrating the suitable size waste material;
sorting the suitable size waste material in a first sorter in order to separate the suitable size waste material into a first organic fraction and a first inorganic fraction;
vibrating the first organic fraction in a second vibrating feeder;
sorting the first organic fraction in a second sorter into a second organic fraction and a second inorganic fraction so that the second organic fraction contains less inorganic material than the first organic fraction;
collecting the second organic fraction.

2. The method of claim 1, further comprising:
vibrating the first inorganic fraction in a third vibrating feeder;
sorting the first inorganic fraction in a third sorter into a third organic fraction and a third inorganic fraction in order to increase the yield of organic material available for collection;
collecting the third organic fraction.

3. The method of claim 2, further comprising:
adding the third organic fraction to the second organic fraction.

4. The method of claim 2, wherein sorting the first inorganic fraction in the third sorter further comprises sorting the first inorganic fraction in an x-ray sorter.

5. The method of claim 2, wherein sorting the first inorganic fraction in the third sorter further comprises sorting the first inorganic fraction in an air aspiration type sorter.

6. The method of claim 2, wherein sorting the first inorganic fraction in the third sorter further comprises sorting the first inorganic fraction in a density type sorter.

7. The method of claim 1, wherein sizing the waste material to be the first size further comprises sizing the waste material to be two inch minus waste material.

8. The method of claim 4, wherein separating out the second size waste material further comprises separating out waste material being 0.5 inch minus waste material.

9. A method of sorting waste material to separate compostable material, comprising:
sizing a waste material to be a first size waste material;
delivering the first size waste material to a sizing screen;
separating out a second size waste material from the first size waste material by use of a sizing screen, wherein the second size waste material is removed and the remaining first size waste material is referred to as suitable size waste material;
delivering to a first vibrating feeder the suitable size waste material;
vibrating the suitable size waste material;
sorting the suitable size waste material in a first sorter in order to separate the suitable size waste material into a first organic fraction and a first inorganic fraction;
vibrating the first inorganic fraction in a second vibrating feeder;
sorting the first inorganic fraction in a second sorter into a second organic fraction and a second inorganic fraction so that the second inorganic fraction contains less organic material than the first inorganic fraction;
collecting the second organic fraction.

10. The method of claim 9, further comprising:
adding the second organic fraction to the first organic fraction.

11. The method of claim 1, wherein sorting the suitable size waste material in the first sorter further comprises sorting the suitable size waste material in an x-ray sorter.

12. The method of claim 11, wherein sorting the first organic fraction in the second sorter further comprises sorting the first organic fraction in an x-ray sorter.

13. The method of claim 1, wherein the method is performed generally in line so that the suitable size waste material being sorted does not encounter any sharp side to side changes in its path.

14. A sorting system, comprising:
a sizing screen, wherein the sizing screen defines a plurality of interfacial openings of a second size so that second size or smaller waste material is filtered out from a waste material being sorted by the sizing screen;
a first vibrating feeder positioned to receive the waste material from the sizing screen so that the waste material being sorted is received and vibrated;
an accelerated conveyor positioned to receive the waste material from the first vibrating feeder;
a first sorting device positioned to receive the waste material from the accelerated conveyor, wherein the first sorting device is calibrated to sort the waste material into a first organic fraction and a first inorganic fraction;
a second vibrating feeder positioned to receive the first organic fraction from the first sorting device;
a second sorting device positioned to receive the first organic fraction from the second vibrating feeder, wherein the second sorting device is calibrated to sort the first organic fraction into a second organic fraction and a second inorganic fraction.

15. The sorting system of claim 14, further comprising:
a third vibrating feeder positioned to receive the first inorganic fraction from the first sorting device;
a third sorting device positioned to receive the first inorganic fraction form the third vibrating feeder, wherein the third sorting device is calibrated to sort the first inorganic fraction into a third organic fraction and a third inorganic fraction so that the yield of organic material increases.

16. The sorting system of claim 15, wherein each of the sizing screen, the first vibrating feeder, the accelerated conveyor, the first sorting device, the second vibrating feeder, the second sorting device, the third vibrating feeder, and the third sorting device are positioned generally in line so that the waste material being sorted does not travel on a sharply angled horizontal path.

17. The sorting system of claim 14, further comprising a material sizing device positioned to deliver the waste material to be sorted to the sizing screen, wherein the sizing device sizes waste material to a first size.

18. The sorting system of claim 17, wherein the first size is two inch minus.

19. The sorting system of claim 14, wherein each of the sizing screen, first vibrating feeder, accelerated conveyor, first sorting device, second vibrating feeder, and second sorting device are positioned generally in line so that the waste material being sorted does not travel on a sharply angled horizontal path.

20. The sorting system of claim 14, wherein the plurality of interfacial openings are sized so that 0.5 inch minus waste material is filtered out from the waste material being sorted by the sizing screen.

21. The sorting system of claim 15, wherein the third sorting device is an x-ray sorter.

22. The sorting system of claim 15, wherein the third sorting device is an aspiration type sorter.

23. The sorting system of claim 15, wherein the third sorting device is a vibratory destoner sorter.

24. The sorting system of claim 14, further comprising a collection container positioned to receive the second organic fraction from the second sorting device.

25. The sorting system of claim 14, further comprising a collection container positioned to receive the third organic fraction from the third sorting device.

26. The sorting system of claim 14, wherein the sizing screen is a debris roll screen.
